(19) United States
(12) Patent Application Publication
(10) Pub. No.: US 2005/0038730 A1
(43) Pub. Date: Feb. 17, 2005

(54) Intellectual property tracking stock

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 10/640,816

(22) Filed: Aug. 14, 2003

(51) Int. Cl. G06F 17/60

(52) U.S. Cl. 705/37

(57) ABSTRACT

A method and instrument for allowing public investment in an intellectual property (IP) business, such as a patent business, of a publicly held corporation. An exemplary method comprises defining an IP business within the corporation, and issuing a stock to the public that tracks the performance of the IP business. An exemplary instrument comprises a stock issued to the public for tracking the performance of an IP business within the corporation. The IP business may be defined to be coextensive with the corporation's intellectual property business division (IPBD). Alternatively, the IP business may be defined to be coextensive with the corporation's IP, or a part of its IP, such as issued and pending patents. The establishment of such an IP tracking stock has numerous advantages, including increasing the visibility of the corporation's IP, appealing to a class of investors who are not interested in holding the corporation's ordinary stock, raising cash for the corporation via an IPO in the IP tracking stock, incentivizing employees working in the corporation's IPBD via issuance of shares or options in the IP tracking stock, providing a non-cash currency which can be used to acquire third party IP, and creating a market-based measure of value for the corporation's IP or a part thereof. Moreover, using the vehicle of the IP tracking stock allows the corporation to obtain these advantages without having to relinquish control over the IPBD or ownership of the IP.

### BACKGROUND OF INVENTION

The present invention is directed to a method and instrument for allowing corporations to capitalize their intellectual property (IP), such as their patents.

Intellectual property exploitation via outbound licensing is on the rise. This is particularly true of outbound patent licensing. Several factors explain the recent surge. An increasing percentage of patents are never productized by companies due to rapidly changing business priorities. Patents that are not productized yield no excess profits from direct exploitation; that is, from sales of patented articles, and therefore have little value outside licensing. Even patents that are productized yield little in the way of excess profits unless the patentee is willing to spend the time and money, and incur the risks of litigation, to stop infringement. The profit margin from a successful patent licensing program can also be extremely high. This combination of practical obstacles to reaping excess profits from sales of patented articles and huge margin potential from licensing has given companies significant incentives to open up their entire patent portfolios to licensing and aggressively pursue licensing opportunities.

The vehicle many corporations have chosen to exploit patent licensing opportunities is the intellectual property business division (IPBD). An IPBD is generally set up as a peer to other, more traditional business divisions within a corporation. For example, an IPBD typically has its own division management structure and profit-and-loss responsibility. The primary difference separating the IPBD from traditional business divisions is that the IPBD's main charge is marketing the corporation's IP, such as patents, apart from any article of manufacture. Through this marketing of “pure” IP, the IPBD seeks to generate revenue in consideration for grants of IP rights, for example, nonexclusive patent licenses.

While the IPBD is destined to play a central role in maximizing the profit potential of a corporation's IP, the IPBD's own potential as an organizational form has not yet been fully realized. Particularly, the IPBD's separate management structure, separate profit and loss responsibility and high margin potential create opportunities for corporations to exploit the IPBD as an organizational form for the benefit of the corporation as a whole. Indeed, the viability of “pure” IP as a business permits a corporation to avail itself of certain of these opportunities even without formally establishing an IPBD.

### SUMMARY OF THE INVENTION

The present invention, in a basic feature, is directed to a method and instrument for allowing public investment in an IP business, such as a patent business, of a publicly held corporation.

In one aspect, the present invention is directed to such a method that comprises defining an IP business within the corporation, and issuing a stock to the public that tracks the performance of the IP business.

In another aspect, the present invention is directed to such an instrument that comprises a stock issued to the public for tracking the performance of an IP business within the corporation.

The IP business may be defined to be coextensive with the corporation's IPBD. Alternatively, the IP business may be defined to be coextensive with the corporation's IP, or a part of its IP, such as issued and pending patents.

The establishment of an IP tracking stock in accordance with the above aspects of the invention has numerous advantages. Among these include increasing the visibility of the corporation's IP, appealing to a class of investors who are not interested in holding the corporation's ordinary stock, raising cash for the corporation via an IPO in the IP tracking stock, incentivizing employees working in the corporation's IPBD via issuance of shares or options in the IP tracking stock, providing a non-cash currency which can be used to acquire third party IP, and creating a market-based measure of value for the corporation's IP or a part thereof. Moreover, using the vehicle of the IP tracking stock allows the corporation to obtain these advantages without having to relinquish control over the IPBD or ownership of the IP.

These and other aspects and advantages of the present invention will be better understood by reference to the following detailed description taken in conjunction with the accompanying drawings that are briefly described below. Of course, the actual scope of the invention is defined by the appended claims.

### BRIEF DESCRIPTION OF THE DRAWINGS

FIG. 1 shows an organizational chart for a publicly held corporation having an IPBD.

FIG. 2 shows the respective profit-and-loss bases for the ordinary stock and IP tracking stock of the corporation of FIG. 1.

FIG. 3 shows an organizational chart for a publicly held corporation without an IPBD.

FIG. 4 shows the respective profit-and-loss bases for the ordinary stock and IP tracking stock of the corporation of FIG. 3.

FIG. 5 is a flow diagram illustrating a method for establishing an IP tracking stock.

### DETAILED DESCRIPTION OF THE PREFERRED EMBODIMENT

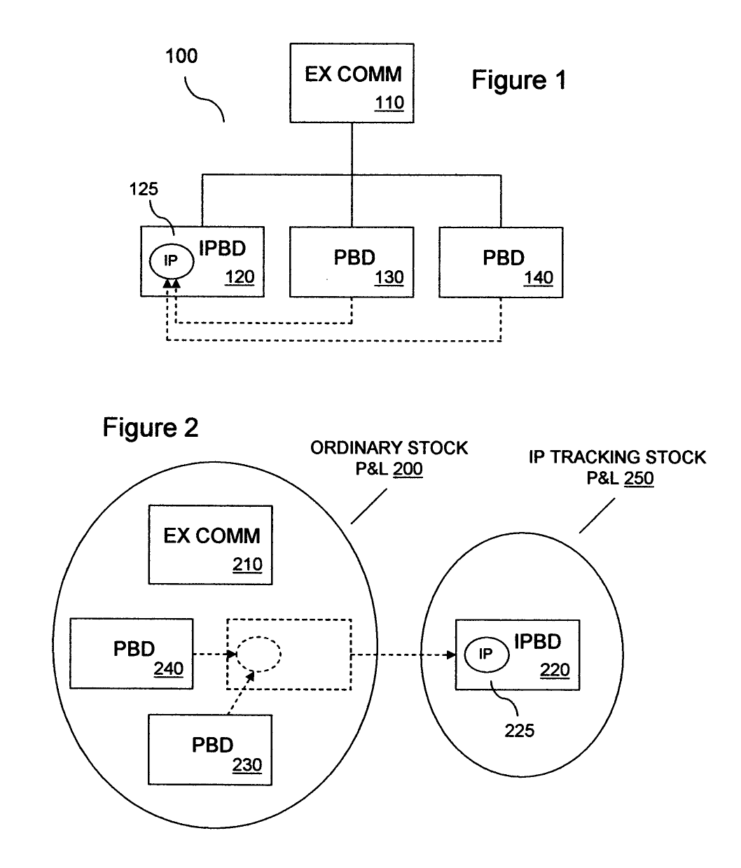

FIG. 1 illustrates an organizational chart 100 for a publicly held corporation having an IPBD 120 and two product business divisions (PBDs) 130, 140. Divisions 120, 130, 140 may be subsidiaries of a corporate parent, or divisions 120, 130, 140 may all be part of a common legal entity. Divisions 120, 130, 140 are peers within the corporation and each have a reporting line to executive committee (EX COMM) 110. As peers, divisions 120, 130, 140 each have their own division management structures and profit-and-loss responsibilities. IPBD 120 differs from PBDs 130, 140, however, in that IPBD has responsibility for marketing the corporation's IP 125, such as patents, copyrights, trademarks, trade secrets and the like, apart from articles of manufacture. PBDs 130, 140, on the other hand, market articles of manufacture and only transfer IP rights attendant to the transfer of such articles.

The cost structure of IPBD 120 includes human capital. The human capital within IPBD 120 includes an IP director; IP prosecution personnel, such as patent lawyers, patent agents and trademark lawyers; and IP licensing personnel. IPBD 120 human capital also includes technical personnel for advising the IP prosecution and IP licensing personnel and conducting reverse engineering studies where indicated. IPBD 120 human capital also includes staff for supporting these personnel, such as clerical and IT personnel. IPBD 120 human capital also includes finance and human resources personnel. Of course, some of these personnel, such as technical, IT, finance and human resources personnel, may be shared with PBDs 130, 140 and thus their cost may be only partially allocated to IPBD 120.

The cost structure of IPBD 120 further includes physical facilities, equipment and outside services (human and otherwise) utilized by IPBD 120. Outside services include, for example, outside IP prosecution services, IP registration and maintenance fees, and telecommunications charges.

The primary marketable asset of IPBD 125 is IP 125. IP 125 includes inventions, works of authorship, trade names, trade dress, know-how and the like, including any granted and pending registrations thereon. Inventions, works of authorship, trade names, trade dress, know-how and the like developed by PBDs 130, 140 are transferred to IPBD 120 and made part of IP 125, which is marketed by IPBD 120. For example, when an engineer working in PBD 130 conceives an improvement for an article of manufacture marketed by PBD 130, the engineer writes an invention disclosure that is delivered to IPBD 120. Patent prosecution and technical personnel within IPBD 120 review the invention disclosure and may elect to file one or more patent applications on the invention, or may elect to not file any applications and keep the invention as a trade secret. In either event, the invention becomes part of IP 125 and is made available by IPBD 120 for sale and fee-based licensing to third parties under the direction of licensing personnel within IPBD 120. In exchange for the transfer of IP from PBDs 130, 140 to IPBD 120, IPBD 120 returns to PBDs 130, 140 a share of the profit from the sale and licensing of IP 125.

From the above discussion, the business model for IPBD 120 can be readily seen. IPBD 120 generates revenue primarily from the sale and licensing of IP 125. Of course, secondary sources of revenue are possible, such as fees received by the personnel of IPBD 120 for speaking at IP seminars. The profit of IPBD 120 is determined after deducting from the generated revenue the costs associated with its generation. These costs include, for example, the cost of IP purchased and licensed from third parties, labor costs associated with personnel working within IPBD 120, costs of physical facilities, equipment and outside services utilized by IPBD 120 and allocations made to PBDs 130, 140 under profit-sharing arrangements made in connection with their respective contributions to IP 125.

Of course, it is possible to limit the scope of IP 125 to a subset of inventions, works of authorship, trade names, trade dress, know-how and the like, and pending and issued registrations thereon. For example, IP 125 may be limited to pending and issued patents. In that event, the primary marketable asset of IPBD 125 is issued and pending patents.

Turning to FIG. 2, the profit-and-loss bases of the ordinary stock and IP tracking stock, respectively, of the corporation of FIG. 1 are shown. Prior to issuing an IP tracking stock, the profit-and-loss of IPBD 220 is combined with the profit-and-loss of PBDs 230, 240 and EX COMM 210 and reported as a consolidated profit-and-loss for the corporation's ordinary stock 200. After issuing an IP tracking stock, however, the profit-and-loss of IPBD 220 is no longer reported in connection with the corporation's ordinary stock 200 and is instead reported as profit-and-loss for the corporation's IP tracking stock 250. That is, while the corporation retains ownership of all the assets of IPBD 220, including IP 225, by issuing the IP tracking stock the holders of the corporation's ordinary stock relinquish their economic interest in the profits and losses reported by IPBD 220. Once the IP tracking stock has been issued, the economic interest in the profits and losses reported by IPBD 220, for example, the right to receive dividends based on profits of IPBD 220, belongs to holders of the IP tracking stock.

Naturally, rather than the complete relinquishment of economic interest in the profits and losses of IPBD 220 by ordinary stock shareholders illustrated in FIG. 2, a partial relinquishment may be effectuated whereby ordinary stock shareholders surrender only a portion of their economic interest in the profits and losses of IPBD 220. The amount of economic interest relinquished is defined by the corporation at the time the IP tracking stock is established.

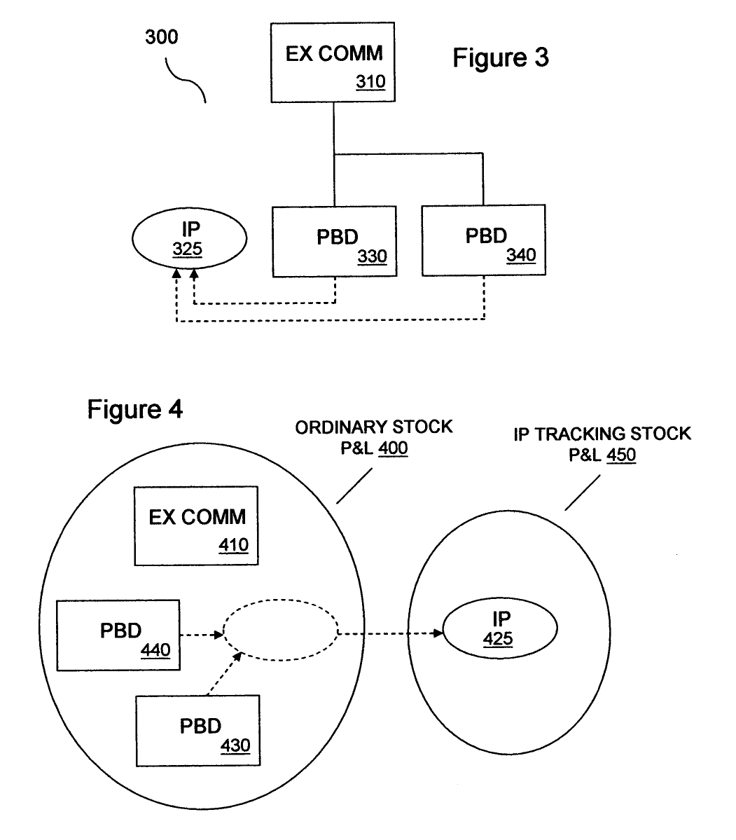

FIG. 3 illustrates an organizational chart 300 for a publicly held corporation without an IPBD. EX COMM 310 and PBDs 330, 340 are similar in structure and function to their counterparts 110, 130, 140 described in FIG. 1. However, as the corporation of FIG. 3 has no IPBD, inventions, works of authorship, trade names, trade dress, know-how and the like developed by PBDs 330, 340, including any granted and pending registrations thereon, become part of IP 325 and are marketed by an outside licensing agent retained by the corporation. For example, when an engineer working in PBD 330 conceives an improvement for an article of manufacture marketed by PBD 330, the engineer writes an invention disclosure that is delivered to outside patent prosecution personnel retained by the corporation. The outside patent prosecution personnel reviews the invention disclosure and in consultation with technical personnel within PBD 330 a decision is made whether to have one or more patent applications filed on the invention by the outside patent prosecution personnel. The invention and any pending or issued patents thereon become part of IP 325 and are made available to the outside licensing agent for sale and fee-based licensing to other third parties. Revenue generated from the sale and licensing of IP 325 pursuant to the efforts of the outside licensing agent is directed to the corporation. The corporation pays fees and costs incurred on the corporation's behalf by the outside patent prosecution personnel and the outside licensing agent.

From the above discussion, the IP business model of the corporation of FIG. 3 can be understood as follows: Revenue is generated from the sale and licensing of IP 325 to third parties. The profit from IP 325 is determined after deducting from the generated revenue the costs associated with its generation. These costs include, for example, the cost of IP purchased and licensed from third parties, and fees and costs associated with representation by the outside IP prosecution counsel and the outside licensing agent.

Turning to FIG. 4, profit-and-loss bases for the ordinary stock and IP tracking stock, respectively, of the corporation of FIG. 3 are shown. Prior to issuing an IP tracking stock, the profit-and-loss associated with the sale and licensing of IP 425 apart from manufactured articles (i.e. of “pure” IP) is combined with the profit-and-loss of PBDs 430, 440 and EX COMM 410 and reported as a consolidated profit-and-loss for the corporation's ordinary stock 400. After issuing an IP tracking stock, however, the profit-and-loss associated with the sale and licensing of “pure” IP 425 is no longer combined with the profit-and-loss of PBDs 430, 440 and EX COMM 410 and is instead reported as profit-and-loss for the corporation's IP tracking stock 450. That is, while the corporation still owns IP 425, the holders of the corporation's ordinary stock have relinquished their economic interest in the profits and losses associated with the sale and licensing of “pure” IP 425.

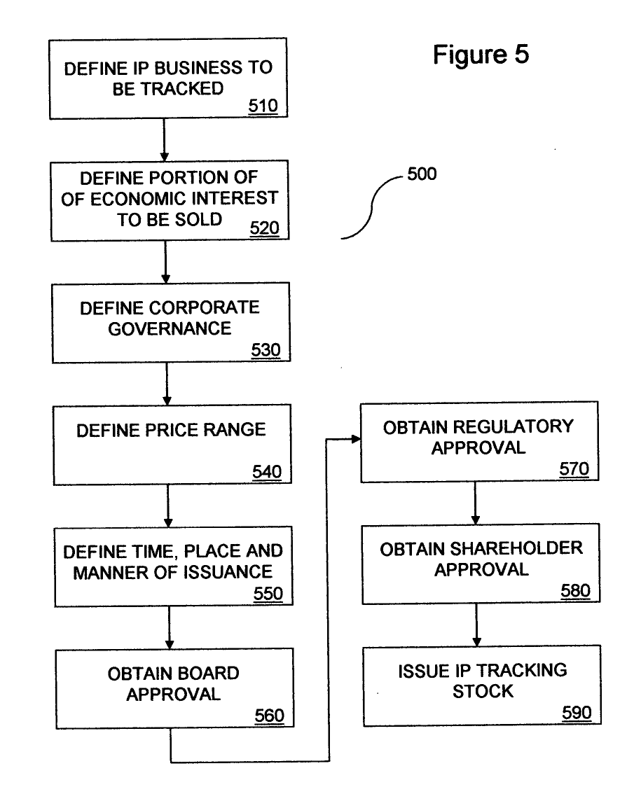

Turning finally to FIG. 5, a flow diagram 500 illustrates a method for establishing an IP tracking stock. Steps 510 through 550 and 580 are typically performed by management within the corporation in consultation with in-house and outside legal personnel and outside underwriters. Steps 560 and 570 are typically performed by management within the corporation in consultation with in-house and outside legal personnel.

At Step 510, an IP business to be tracked is defined. The IP business may be defined to be coextensive with the corporation's IPBD. Alternatively, the IP business may be defined to be coextensive with the corporation's IP, or a part of its IP. In any case, the profit from the IP business will be determined after deducting from revenue generated at least primarily through sale and licensing of the IP the costs associated with its generation.

At Step 520, the portion of economic interest to be sold in the IP business is defined. The portion of economic interest to be sold may be up to 100 percent.

At Step 530, corporate governance matters associated with the IP business are defined. This step includes determination of to what extent, if any, shares in the IP tracking stock will have voting rights in the corporation and whether the IP business will have its own board of directors.

At Step 540, a price range for the portion of economic interest to be sold in the IP business is defined.

At Step 550, the time, place and manner of issuance of an IP tracking stock in accordance with the determinations made in Steps 510 through 540 is defined. This step includes determination of such matters as the exchange where the IP tracking stock will be listed, a ticker symbol for the IP tracking stock, a proposed issue date and whether the IP tracking stock will be issued to existing shareholders, or as part of an initial public offering.

At Step 560, approval of issuance of the IP tracking stock in accordance with the determinations made in Steps 510 through 550 is sought and obtained from the corporation's board of directors.

At Step 570, regulatory approval of issuance of the IP tracking stock in accordance with the determinations made in Steps 510 through 550 is sought and obtained from the appropriate governmental authorities.

At Step 580, approval of issuance of the IP tracking stock in accordance with the determinations made in Steps 510 through 550 is sought and obtained from the shareholders of the ordinary stock.

At Step 590, the IP tracking stock is issued in accordance with the determinations made in Steps 510 through 550.

It will be appreciated by those of ordinary skill in the art that the invention can be embodied in other specific forms without departing from the spirit or essential character hereof. The present invention is therefore considered in all respects to be illustrative and not restrictive. The scope of the invention is indicated by the appended claims, and all changes that come within the meaning and range of equivalents thereof are intended to be embraced therein.

1. A method for allowing investment in intellectual property controlled by a publicly held corporation, comprising:
defining an intellectual property business within the corporation; and
issuing a stock to the public that tracks performance of the intellectual property business.

2. The method of claim 1, wherein intellectual property controlled by the corporation is the primary marketable asset of the intellectual property business.

3. The method of claim 1, wherein the intellectual property business generates most of its revenue by granting rights in intellectual property controlled by the corporation apart from any article of manufacture.

4. The method of claim 1, wherein the intellectual property business is coextensive with a business division operating within the corporation.

5. The method of claim 2, wherein the intellectual property includes one or more of patents, trademarks, copyrights and trade secrets.

6. A stock issued to the public for tracking performance of an intellectual property business of a publicly held corporation.

7. The stock of claim 6, wherein intellectual property controlled by the corporation is the primary marketable asset of the intellectual property business.

8. The stock of claim 6, wherein the intellectual property business generates most of its revenue by granting rights in intellectual property controlled by the corporation apart from any article of manufacture.

9. The method of claim 6, wherein the intellectual property business is coextensive with a business division operating within the corporation.

10. The method of claim 7, wherein the intellectual property includes one or more of patents, trademarks, copyrights and trade secrets.

11. A method for allowing investment in patents controlled by a publicly held corporation, comprising:
defining a patent business within the corporation; and
issuing a stock to the public that tracks performance of the patent business.

12. The method of claim 11, wherein patents controlled by the corporation are the primary marketable asset of the patent business.

13. The method of claim 11, wherein the patent business generates most of its revenue by granting rights in patents controlled by the corporation apart from any article of manufacture.

14. The method of claim 11, wherein the patent business is coextensive with a business division operating within the corporation.

15. The method of claim 12, wherein the patents include issued and pending patents.

16. A stock issued to the public for tracking performance of a patent business of a publicly held corporation.

17. The stock of claim 16, wherein patents controlled by the corporation are the primary marketable asset of the patent business.

18. The stock of claim 16, wherein the patent business generates most of its revenue by granting rights in patents controlled by the corporation apart from any article of manufacture.

19. The method of claim 16, wherein the patent business is coextensive with a business division operating within the corporation.

20. The method of claim 17, wherein the patents include issued and pending patents.
